(19) United States
(12) Patent Application Publication
(10) Pub. No.: US 2007/0281751 A1
(43) Pub. Date: Dec. 6, 2007

(54) METHOD AND APPARATUS FOR ENABLING A USER TO INTERRUPT THE SUPPLY OF A SERVICE TO THE USER

(76) Inventors: Frederic Bauchot, Saint-Jeannet (FR); Jean-Yves Clement, Saint-Jeannet (FR); Gerard Marmigere, Drap (FR); Joaquin Picon, St. Laurent Du Var (FR)

Correspondence Address: HOFFMAN, WARNICK & D'ALESSANDRO LLC, 75 STATE ST, 14 FL, ALBANY, NY, 12207, US

(21) Appl. No.: 11/736,700

(22) Filed: Apr. 18, 2007

(30) Foreign Application Priority Data
Apr. 25, 2006 (EP) 06300403.0

(51) Int. Cl. H04M 1/00

(52) U.S. Cl. 455/567

(57) ABSTRACT

A module for transferring a warning signal emitted by a communications device to a user of a media broadcasting device. In an embodiment, the module includes: a receiver for receiving the warning signal; a connection for interposing the module between the media broadcasting device and a head-phone; and a switch for transferring a received warning signal to the head-phone.

### FIELD OF THE INVENTION

The present invention relates to a method and apparatus for enabling a user to interrupt the supply of a service to the user. More particularly, the present relates to a method and apparatus for enabling a user to choose to listen to a telephone during an MP3 session.

### BACKGROUND OF THE INVENTION

MP3 players are very much the device to have and users are often “plugged in” to listen to music. The music can be heard through headphones which are connected by a wire or cable to the MP3 player. When the user is plugged in and music is playing the user cannot hear things that are going on in the vicinity.

In particular, if a mobile phone rings the user will not hear the ringing and may miss important calls. By setting ring volume as high as possible and reducing the MP3 volume it may be possible to hear the phone ring if it is close by. However, this is not usually what happens.

There have been a number of attempts to solve this problem. For example, WO 03/034782 discloses a modular head set which has more than one operating mode, for instance, using Bluetooth and/or wired connections (Bluetooth is a registered trademark of Bluetooth SIG, Inc., in the United States and/or other countries). For a user to benefit from the obvious advantages of the invention disclosed in WO 03/034782, they must purchase a new headset. This adds to the cost of having an MP3 player. Another disadvantage is that the substitution of one functionality for another as provided to the user requires a positive action from the user on a key pad.

Accordingly, there is a need in the art for a method and apparatus which solves at least some of the problems of the prior art.

### SUMMARY OF THE INVENTION

The present invention is directed to a module for transferring a warning signal, emitted by a communications device, to a user of a media broadcasting device, the module comprising: a receiver for receiving the warning signal; a connection for interposing the module between the media broadcasting device and a head-phone; and a switch for transferring a received warning signal to the head-phone.

The present invention is further directed to a method for transferring a warning signal, emitted by a communication device, to a user of a media broadcasting device, wherein the method comprises: connecting a module for receiving the warning signal to the media-broadcasting device, attaching a head-phone to the media-broadcasting device, using the module as a connector between the head-phone and the media-broadcasting device, and providing the module with receiver and transfer means, for receiving the warning signal emitted by the communication device and for transferring the warning signal to the user, using the head-phone.

Using the present invention, it is not necessary to change any existing equipment. It is necessary only to attach the module between the normal MP3 headphones and the MP3 player to enable the user to detect and react to any incoming telephone call. The module is simple and inexpensive and the user does not have to replace any existing equipment.

In addition, the module knows when a telephone call is received and the user may then choose which action to take next, for example, to answer the call or not by picking up the phone. Alternately if the module includes a microphone the user may actually receive the call through the module.

### BRIEF DESCRIPTION OF THE DRAWINGS

FIG. 1 is a diagram showing the elements of the present invention in simplified terms.

FIG. 2 is a detailed diagram of the FIG. 1 module illustrating the functionality of the invention in greater detail.

FIG. 3 is a flow chart showing the operation of the module in use.

### DETAILED DESCRIPTION OF THE INVENTION

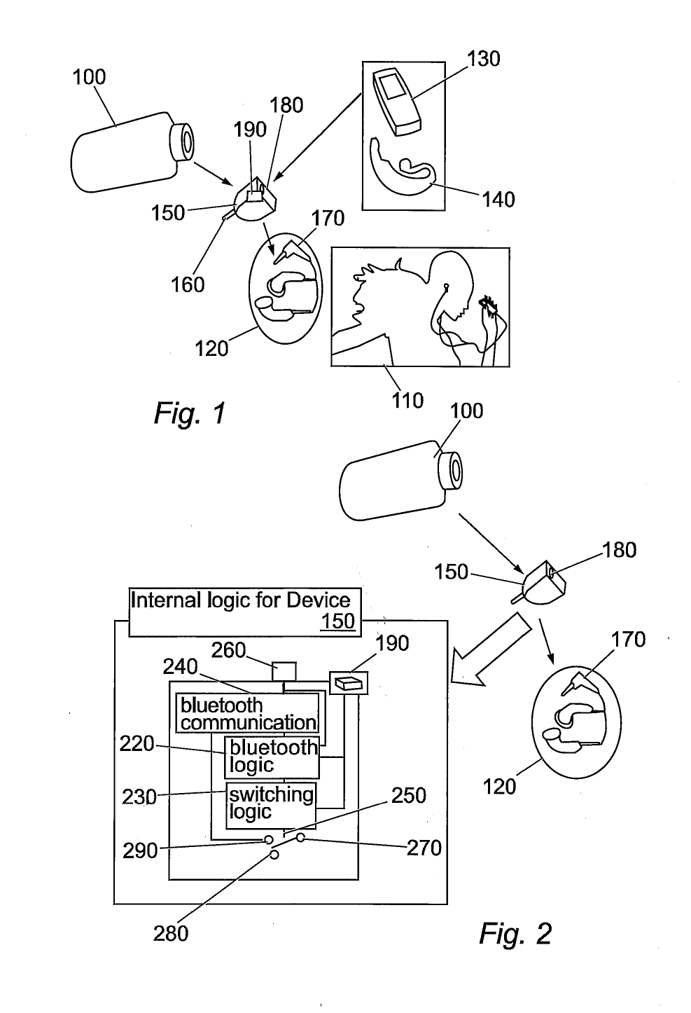

FIG. 1 shows an MP3 player 100, which is used to provide an auditory medium to a user 110 through a headset 120. The auditory medium may be music, audio for a video or any other source. The MP3 player 100 is merely an example and other media broadcasting devices with headphones are equally as relevant to the invention. The user 110 also has a mobile telephone 130 (or other device that provides a communication or telephony service or a similar wireless device) which has a Bluetooth earpiece or headset 140.

The present invention includes the use of a module 150. The module 150 comprises a jack plug connector 160, which can be connected into the MP3 player 100. The connector 160 may be a different type if necessary as long as it corresponds within the headphone plug 170 for headphones 120 and can plug into device 100 (whatever type it might be). The headphone plug 170 is then plugged into a female connector 180 in the module 150, thus re-establishing the audio connection between MP3 player 100 and the headphones 120. The module 150 further includes a button 190, the function of which will be described in greater detail with respect to the internal functioning of the module 150.

The module 150 may include a microphone on any surface thereof, to allow the user 110 to speak into the module 150. Again the function of the microphone will be described in greater detail below. The module 150 may be of any shape, size, color or form.

Referring now to FIG. 2, details of the internal logic of module 150 will be described. The module 150 includes Bluetooth logic block 220, which is connected to switching logic block 230 and a Bluetooth communication block 240. The function of each block will be described in greater detail below. The switch 190 is connected to the switching logic block 230 and the Bluetooth logic block 220 for activating, deactivating, or carrying out a particular function as will be described below. A microphone 260 may be included and connected to the Bluetooth logic and communication blocks 220, 240. The switching logic block 230 operates a switch 250 which can change the headset connection 270 from the MP3 player connection 280 to the telephone connection 290.

The following description now sets out operation of the module 150. Prior to or during listening to content from the MP3 player 100, the Bluetooth logic communication function is synchronised with the telephone 130. This is achieved by pushing button 190 in a first manner (e.g., two pushes might be used to synchronise the Bluetooth with the telephone 130). This is due to the fact that the module 150 only includes one button which has several functions. It can be possible to have more than one button each for a different function.

Once the telephone 130 and the Bluetooth of the module 150 are synchronised, the user 110 can listen to or continue listening to the output from the MP3 player 100. The switch 250 is set to the MP3 connection 280 and the user 110 listens to music or other content from the MP3 player 100. When a telephone call is received at the telephone 130, the telephone 130 notifies the Bluetooth in the module 150. The Bluetooth logic and communication blocks 220, 240 activate the switching logic 230 to switch the switch 250 to the telephone connection 290. In this way, the user 110 can now hear the telephone 130 ringing or hear a warning of a call instead of hearing the content from the MP3 player 100.

The user 110 now has a number of options, including:
1. Pick up and answer the telephone 130. The Bluetooth logic 220 may then activate the switch 250 back to the MP3 connection 280 to connect to the MP3 player 100.
2. The user 110 can choose to ignore the warning signal and press button 190. The pressing of the button 190 in a second manner in this circumstance being operable to inform the switching logic 230 to switch the switch 250 back to the MP3 connection 280.
3. If the module 150 includes a microphone 260 the user 110 can press the button 190 in a third manner to receive the call at the module 150. The Bluetooth makes the connection and transfers the audio from the telephone 130 via the headphones 120 to the user 110 and the voice from the microphone 260 to the telephone caller via the Bluetooth and telephone 130 in a known manner.

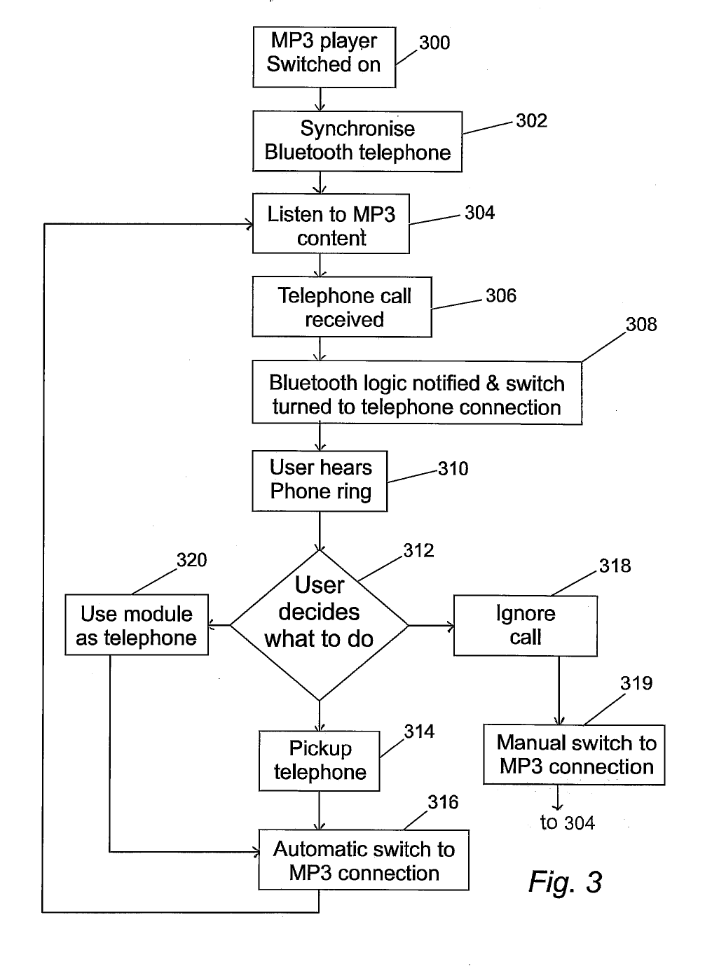

Referring now to FIG. 3, an illustrative process for using the module 150 and for carrying out the invention is described.

The MP3 player 100 is switched on and the module 150 connected (300). The Bluetooth of the module 150 is synchronised with the telephone 130 either during or before the user 110 listens to the MP3 content (302). The user 110 then continues to listen to the MP3 content (304).

A telephone call is then received (306). The Bluetooth logic block 220 is notified by the Bluetooth communication block 240 and the switch 250 is turned to the telephone connection 290 (308). As a result, the user 110 can hear the ring of the telephone 130 (310).

The user 110 then makes the decision of what to do (312). The user 110 may ignore the call (318) and manually switch the switch 250 back to the MP3 connection 280 (319) and continue listening to the MP3 content (304). The user 110 may stop listening to the MP3 player 100, remove the headset 120 and pick up to telephone 130 (314). Once the telephone call is completed, the Bluetooth recognises there is no connection to the telephone 130 and the switch 250 is automatically switched back to the MP3 connection 280 (316).

Alternatively, the user 110 can answer the call and communicate to the caller using the module 150 as a telephone or intermediary to the telephone 130 (320). The switch 250 is automatically switched back to the MP3 connection 280 after the call is completed (316).

While the invention has been particularly shown and described with reference to a preferred embodiment, it will be understood that various changes in form and detail may be made therein without departing from the spirit, and scope of the invention.

1. A module for transferring a warning signal emitted by a communications device to a user of a media broadcasting device, the module comprising:
a receiver for receiving the warning signal;
a connection for interposing the module between the media broadcasting device and a head-phone; and
a switch for transferring a received warning signal to the head-phone.

2. The module of claim 1, wherein the communications device is a mobile telephone and the warning signal is an incoming call to the telephone.

3. The module of claim 1, wherein the receiver is a Bluetooth receiver.

4. The module of claim 1, wherein the module further comprises:
an actuator for effecting an action after the warning signal has been received.

5. The module of claim 4, wherein the actuator can be used to allow the user to ignore the warning signal.

6. The module of claim 4, wherein the actuator can be used to synchronise the module with the communications device.

7. The module of claim 1, wherein the warning signal automatically switches the switch when received by the receiver.

8. The module of claim 1, wherein the module further comprises:
a microphone to allow the user to send communications to the communications device.

9. A method for transferring a warning signal, emitted by a communication device, to a user of a media broadcasting device, wherein the method comprises:
connecting a module for receiving the warning signal to the media-broadcasting device;
attaching a head-phone to the media-broadcasting device, using the module as the connector between the head-phone and the media-broadcasting device; and
providing the module with receiver and transfer means, for receiving the warning signal emitted by the communication device and for transferring the warning signal to the user, using the head-phone.

10. The method of claim 9, further comprising:
synchronising the module with the communications device.

11. The method of claim 9, further comprising:
identifying a termination of the warning signal; and
re-transferring an output of the media broadcasting device to the head-phone.

12. The method of claim 9, wherein the communications device is a mobile telephone and the warning signal is an incoming call to the telephone.

13. The method of claim 9, wherein the receiver and transfer means further comprises:
a Bluetooth receiver.

14. The method of claim 9, further comprising:
effecting an action after the warning signal has been received by the module.

15. The method of claim 9, further comprising:
allowing the user to ignore the warning signal.

16. The module of claim 9, further comprising:
allowing the user to send communications to the communications device using a microphone on the module.
